(19) United States
(12) Patent Application Publication
(10) Pub. No.: US 2007/0058895 A1
(43) Pub. Date: Mar. 15, 2007

(54) Anti-friction thrust bearing centering device for hermetic refrigeration compressors

(76) Inventor: Marcelo Ribeiro Paschoalino, Sao Carlos (BR)

Correspondence Address: CHRISTIE, PARKER & HALE, LLP, PO BOX 7068, PASADENA, CA, 91109-7068, US

(21) Appl. No.: 11/226,800

(22) Filed: Sep. 13, 2005

(51) Int. Cl. F16C 33/02; F16C 33/16; F16C 33/10; F16C 5/00; F16C 3/14; F16C 1/24; F16C 1/00

(52) U.S. Cl. 384/617

(57) ABSTRACT

A device for centering anti-friction thrust bearings, used in hermetic refrigeration compressors may comprise a cylindrical segment with an internal circular rim and an elevated step-like upper face over the circular rim and along an internal border of the circular rim. The cylindrical segment may sit in an internal housing of an axle inside a motor, and may be guided by an external diameter of an axle hub that fits over the anti-friction thrust bearing with the internal circular rim supporting a lower washer of the anti-friction thrust bearing. Essentially frictionless rotation of the axle within the bearing may be provided by eliminating most radial displacements of components of the anti-friction thrust bearing.

### TECHNICAL FIELD

This application relates to motorized machines such as hermetic refrigeration compressors and anti-friction thrust bearings used in such compressors and, more specifically, to a device for maintaining the position of bearings within a machine.

### BACKGROUND

A hermetic refrigeration compressor may include internal parts that move with respect to one another. Some of these internal parts may be connected by journal bearings.

Journal bearings typically are used as rotor supports in industrial machinery such as turbines, centrifugal compressors, pumps and motors. One use of a journal bearing is to provide a relatively frictionless environment to support and guide a rotating shaft. Here, a journal bearing may comprise a cylinder which surrounds the shaft and is filled with some form of fluid lubricant such that the fluid is the medium that supports the shaft to help prevent metal to metal contact.

Journal bearings are usually fabricated using iron, steel or aluminum alloys. One of the last operations to which the material is subjected during fabrication is a surface treatment called phosphatization.

A hydrodynamic journal bearing is an element that may be applied between two rigid pieces that move with respect to one another. The hydrodynamic journal bearing may include a lubricating fluid between the moving rigid pieces for the purpose of substituting the dry friction between them with viscous friction.

Another type of journal bearing uses anti-friction thrust bearings between two moving contact surfaces. Anti-friction thrust bearings may be used in some hermetic refrigeration compressors for the purpose of facilitating the movement of the parts in contact by reducing the friction, the working temperature, and the premature wear of the surfaces of the parts in contact.

Conventional hermetic compressors may have radial and axial journal bearings between the central axle and the body housings where the central axle rests. The compressor body is fixed and does not move while its axle rotates with an angular speed imposed by an electric motor. Thus, the central axle of the hermetic compressor moves with respect to the housings of the axle where the axle rests.

Some hermetic refrigeration compressor models use anti-friction thrust bearings in the contact areas that are used for support of rotating parts.

During the operation of hermetic refrigeration compressors, the components of anti-friction thrust bearings, such as the washers and the spheres cages, can move in a radial fashion due to pressures and backlashes from the existing assembly. However, each new start up of the hermetic compressor is critical because the pump has not yet injected the oil. During each new startup, the radial displacement of the component parts of the anti-friction thrust bearing can be intensified. As a result, the washer or its lower track may touch the central axle of the compressor thereby damaging the axle as well as the anti-friction thrust bearing housing. This damage may lead to an eventual chipping and other problems.

Due to the above circumstances and with the purpose of overcoming them, the anti-friction thrust bearing centering device of this application was designed for hermetic refrigeration compressors.

### SUMMARY

The invention relates to a centering device for bearings such as anti-friction thrust bearings used in machines such as hermetic compressors. For convenience, an embodiment of a system constructed according to the invention may be referred to herein simply as an “embodiment.”

In some embodiments a centering device may comprise a cylindrical segment that is guided by an external diameter of a central axle hub of a machine body such as a compressor body. The centering device may thereby guide and center a lower track or washer of an anti-friction bearing in the machine housing which is formed to receive it.

Accordingly, a centering device may substantially prevent radial movement of the components of an anti-friction thrust bearing. In addition the centering device may maintain the anti-friction thrust bearing substantially centered in its housing. Further, the centering device may help retain lubricating oil, thus maintaining proper lubrication of the spheres cage of the anti-friction thrust bearing.

In some embodiments a device for centering an anti-friction thrust bearing used in hermetic refrigeration compressors may comprise of a cylindrical segment of polymeric material, equipped with an internal circular rim approximately at the middle, with an upper face equipped with a substantially circular level, along its internal border, wherein the cylindrical segment is applied in the housing provided for the installation of the anti-friction thrust bearing of the hermetic refrigeration compressor, guided by the external diameter of its axle hub, and with the internal rim offering support to the track or lower washer of the anti-friction thrust bearing installed there.

### BRIEF DESCRIPTION OF THE DRAWINGS

These and other features, aspects and advantages of the present invention will be more fully understood when considered with respect to the following detailed description, appended claims and accompanying drawings, wherein:

FIG. 1 is a simplified diagram showing, in perspective, one embodiment of a centering device constructed in accordance with the invention;

FIG. 2 is a simplified diagram of a plan view of the centering device of FIG. 1;

FIG. 3 is a simplified diagram of a cross-sectional view of the centering device of FIG. 2 as viewed along the cross section marked A-A on FIG. 2; and

FIG. 4 is a simplified diagram of a partial cut view of a one embodiment of a hermetic refrigeration compressor including an anti-friction thrust bearing equipped with the centering device constructed in accordance with the invention.

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus or method. Finally, like reference numerals denote like features throughout the specification and figures.

### DETAILED DESCRIPTION

The invention is described below, with reference to detailed illustrative embodiments. It will be apparent that the invention may be embodied in a wide variety of forms, some of which may be quite different from those of the disclosed embodiments. Consequently, the specific structural and functional details disclosed herein are merely representative and do not limit the scope of the invention.

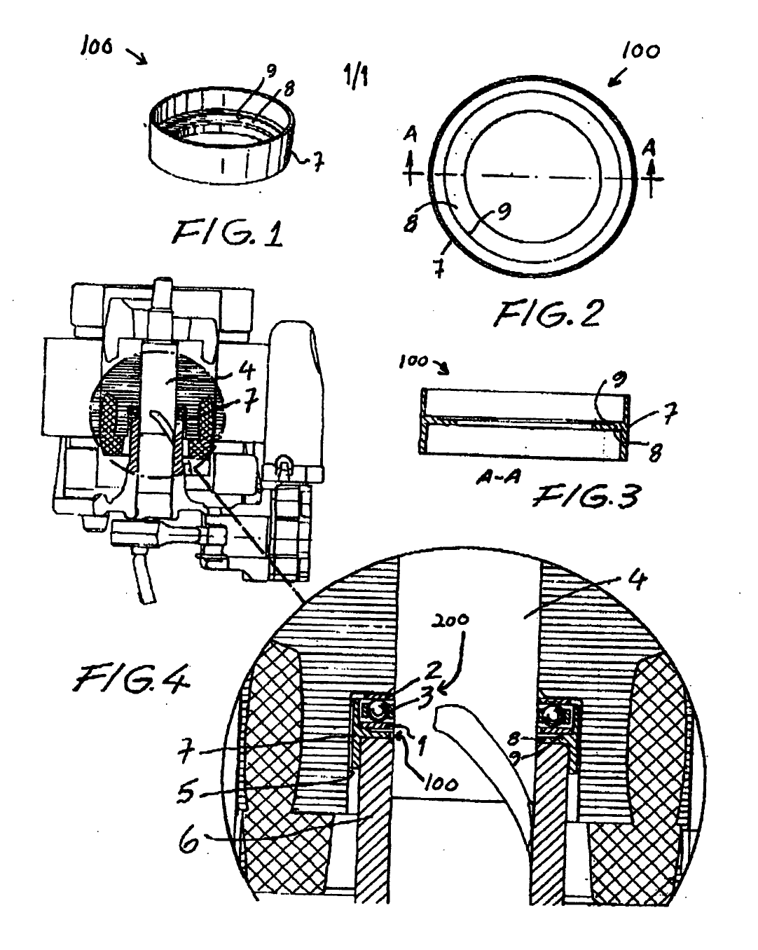

FIG. 1 is a perspective view of one embodiment of a centering device 100 constructed in accordance with the invention. As seen in FIG. 1, the centering device 100 is comprised of a rectilinear cylindrical segment 7, an internal circular rim 8 and a substantially circular level 9. The substantially circular level 9 forms part of a step from an internal wall of the cylindrical segment 7 to an upper face of the internal circular rim 8. In some embodiments the cylindrical segment 7 and/or the other components may be constructed of a polymeric material.

FIG. 2 is a plan view of the centering device 100. This figure shows the circular cross section of the cylindrical segment 7, the internal circular rim 8, and the substantially circular level 9.

FIG. 3 is a cross-sectional front view of the centering device 100 across the cross section A-A shown in FIG. 2. This figure again illustrates the cylindrical segment 7, the internal circular rim 8, and the substantially circular level 9.

FIG. 4 illustrates one embodiment of how the centering device 100 may be incorporated into a hermetic compressor. This figure shows a hermetic compressor, including an anti-friction thrust bearing, incorporating the centering device 100 and demonstrates the physical relationship of a compressor axle 4 with the centering device 100.

An enlarged inset view shows details of one type of anti-friction thrust bearing 200 that comprises a lower support washer 1 and an upper support washer 2, between which a merged spheres cage 3 lies. An internal housing 5 and an axle hub 6 of the compressor motor also are shown on the inset.

As seen in FIGS. 1 and 4, the cylindrical segment 7 of the centering device 100 is positioned in the internal housing 5 which is formed to receive the anti-friction thrust bearing 200, guided by the external diameter of the central axle hub 6 of the compressor. Cylindrical segment 7, in turn, may guide and center the lower track or washer 1 of the anti-friction thrust bearing 200.

Reiterating, one type of anti-friction thrust bearing 200 for hermetic refrigeration compressors that may be centered by the centering device 100, may comprise a pair of support washers or tracks, the lower support washer 1 and the upper support washer 2, between which the merged spheres cage 3 may lie. This anti-friction thrust bearing 200 may be mounted around the central axle 4 of the hermetic refrigeration compressor, in the internal housing 5 formed within the interior of the compressor, and adjacent to the inside of the axle hub 6.

As seen in different views in FIG. 1, FIG. 2, and FIG. 3, one embodiment of the centering device 100 may include the cylindrical segment 7, made from polymeric material, the internal circular rim 8 that is located approximately at the mid-level of the cylindrical segment 7, and an upper face equipped with the substantially circular level 9 along the internal border. The cylindrical segment 7 may be placed in the internal housing 5 provided for the anti-friction thrust bearing 200 and may be guided by the external diameter of the axle hub 6 of the compressor. The internal circular rim 8 can offer support for the track or lower washer 1 of the anti-friction thrust bearing 200.

FIG. 4 shows the interior of one example of a hermetic refrigeration compressor as a whole together with the anti-friction thrust bearing 200 and the centering device 100. The anti-friction thrust bearing 200 is laid inside the cylindrical segment 7, of the centering device 100 while the centering device 100 lies around axle hub 6 of axle 4. The cylindrical segment 7 maintains the anti-friction thrust bearing 200 essentially centered with respect to the internal housing 5 by impeding most radial displacements of its components. The cylindrical segment 7, at the same time, retains lubricating oil in its interior, thus maintaining the spheres cage 3 lubricated.

Use of the centering device 100 may facilitate the mounting of the anti-friction thrust bearing 200 and ease sliding between the areas of contact. The centering device 100 does so mainly by using the lubricating oil that is held in the centering device 100 even during compressor startup and even when there is little lubricating oil in the machine. The centering device 100 can do so partly because most radial displacement of the components of the anti-friction thrust bearing 200 are eliminated.

It should be appreciated that the various components and features described herein may be incorporated in an apparatus independently of the other components and features. For example, an apparatus incorporating the teachings herein may include various combinations of these components and features. Thus, not all of the components and features described herein may be employed in every such apparatus.

In summary, the invention described herein generally relates to an improved centering device for anti-friction thrust bearings that are used in hermetic refrigeration compressors. While certain exemplary embodiments have been described above in detail and shown in the accompanying drawings, it is to be understood that such embodiments are merely illustrative of and not restrictive of the broad invention. In particular, it should be recognized that the teachings of the invention apply to a wide variety of systems and processes. It will thus be recognized that various modifications may be made to the illustrated and other embodiments of the invention described above, without departing from the broad inventive scope thereof. In view of the above it will be understood that the invention is not limited to the particular embodiments or arrangements disclosed, but is rather intended to cover any changes, adaptations or modifications which are within the scope and spirit of the invention as defined by the appended claims.

What is claimed is:

1. An anti-friction thrust bearing centering device for hermetic refrigeration compressors comprising a rectilinear cylindrical segment, made from polymeric material, and equipped with an internal circular rim, approximately at mid-level, and an upper face equipped with a substantially circular level, along its internal border, wherein the cylindrical segment is applied in an internal housing provided for installation of an anti-friction thrust bearing of hermetic refrigeration compressors for which it is designed, guided by an external diameter of an axle hub of the hermetic refrigeration compressor, and with the internal circular rim offering support to a track or a lower washer of the referred anti-friction thrust bearing installed there.

2. A machine comprising:
a motor comprising an axle;
an internal housing;
an anti-friction thrust bearing;
a device positioned in the internal housing and guided by an external diameter of an axle hub such that the device centers the anti-friction thrust bearing around the axle of the motor, the device comprising:
a cylindrical segment comprising an internal wall;
a circular rim protruding inwardly from the interior wall and partially toward a center of the cylindrical segment, the circular rim supporting a track or a lower washer of the anti-friction thrust bearing; and
a substantially circular level forming a portion of a step from the internal wall of the cylindrical segment to the upper face of the circular rim.

3. The machine of claim 2, wherein the device comprises a polymeric material.

4. The machine of claim 2, wherein the device is configured to lubricate the anti-friction thrust bearing by retaining lubricating oil in an interior of the device.

5. The machine of claim 2, wherein substantially frictionless rotation of the axle within the bearing is achieved by maintaining the anti-friction thrust bearing centered around the axle.

6. The machine of claim 2, wherein the anti-friction thrust bearing is laid inside the cylindrical segment while the centering device lies around an axle hub of the axle thereby maintaining the anti-friction thrust bearing centered with respect to the axle by impeding radial displacement of components of the anti-friction thrust bearing.

7. A device for centering an anti-friction thrust bearing around an axle of a motor, the device comprising:
a cylindrical segment comprising an internal wall;
a circular rim protruding inwardly from the interior wall and partially toward a center of the cylindrical segment, the circular rim comprising an upper face; and
a substantially circular level forming a portion of a step from the internal wall of the cylindrical segment to the upper face of the circular rim.

8. The device of claim 7, wherein the circular rim is located approximately at mid-level along a length of the cylindrical segment.

9. The device of claim 7, wherein the device comprises a polymeric material.
